(19) United States
(12) Patent Application Publication
(10) Pub. No.: US 2024/0242885 A1
(43) Pub. Date: Jul. 18, 2024

(54) MULTILAYER CERAMIC ELECTRONIC DEVICE AND DIELECTRIC MATERIAL

(71) Applicant: TAIYO YUDEN CO., LTD., Tokyo (JP)

(72) Inventor: Koichiro MORITA, Takasaki-shi (JP)

(21) Appl. No.: 18/397,341

(22) Filed: Dec. 27, 2023

(30) Foreign Application Priority Data
Jan. 16, 2023 (JP) 2023-004653

(51) Int. Cl. H01G 4/12; C04B 35/468; H01G 4/30

(52) U.S. Cl. CPC H01G 4/1227; C04B 35/4682; H01G 4/30; C04B 2235/3224; C04B 2235/3236; C04B 2235/3262; C04B 2235/365; C04B 2235/442

(57) ABSTRACT

A multilayer ceramic electronic device includes internal electrodes, dielectric layers each of which includes a main component, a first subcomponent, a second subcomponent, and a third sub component. The main component includes titanium and includes at least one of barium or calcium. A molar ratio of a sum of barium and calcium to titanium is 1.045 or more and 1.100 or less. The first sub component includes 3 mol or more and 6 mol or less of a rare earth element, with respect to 100 mol of titanium in the dielectric layers. The second sub component includes 3 mol or more and 7 mol or less of manganese, with respect to 100 mol of titanium in the dielectric layers. The third sub component includes 0.6 weight % or more and 2.4 weight % or less of borosilicate glass with respect to each of the plurality of dielectric layers.

### CROSS-REFERENCE TO RELATED APPLICATION

This application is based upon and claims the benefit of priority of the prior Japanese Patent Application No. 2023-004653, filed on Jan. 16, 2023, the entire contents of which are incorporated herein by reference.

### FIELD

A certain aspect of the present disclosure relates to a multilayer ceramic electronic device and a dielectric material.

### BACKGROUND

Multilayer ceramic electronic devices such as multilayer ceramic capacitors (MLCCs) are installed in a variety of electronic devices such as smartphones and personal computers.

### SUMMARY OF THE INVENTION

According to an aspect of the embodiments, there is provided a ceramic electronic device including: a plurality of internal electrodes facing each other; a plurality of dielectric layers, each of which includes a main component, a first subcomponent, a second subcomponent, and a third sub component, and is sandwiched between the plurality of internal electrode; and an external electrode that is electrically connected to at least a part of the plurality of internal electrodes, wherein the main component has a perovskite structure expressed by a general expression ABO₃, includes titanium and includes at least one of barium or calcium, wherein a molar ratio of a sum of barium and calcium to titanium is 1.045 or more and 1.100 or less, in the main component, wherein the first sub component includes 3 mol or more and 6 mol or less of a rare earth element, with respect to 100 mol of titanium in each of the plurality of dielectric layers, wherein the second sub component includes 3 mol or more and 7 mol or less of manganese, with respect to 100 mol of titanium in each of the plurality of dielectric layers, and wherein the third sub component includes 0.6 weight % or more and 2.4 weight % or less of borosilicate glass with respect to each of the plurality of dielectric layers.

According to an aspect of the embodiments, there is provided a dielectric material including: a main component, a first sub component, a second sub component, and a third sub component, wherein the main component has a perovskite structure expressed by a general expression ABO₃, includes titanium and includes at least one of barium or calcium, wherein a molar ratio of a sum of barium and calcium to titanium is 1.045 or more and 1.100 or less, in the main component, wherein the first sub component includes 3 mol or more and 6 mol or less of a rare earth element, with respect to 100 mol of titanium in the dielectric material, wherein the second sub component includes 3 mol or more and 7 mol or less of manganese, with respect to 100 mol of titanium in the dielectric material, and wherein the third sub component includes 0.6 weight % or more and 2.4 weight % or less of borosilicate glass with respect to the dielectric material.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4 is a schematic cross sectional view of dielectric grains in a dielectric layer;

FIG. 5 illustrates a flow of a manufacturing method of a multilayer ceramic capacitor;

FIG. 6A and FIG. 6B illustrate a forming process of an internal electrode;

FIG. 7 illustrates a crimping process;

FIG. 8 illustrates a side margin; and

FIG. 9 illustrates a changing of capacity of Examples 2, 3, 8 and a comparative example 1.

### DETAILED DESCRIPTION

In recent years, multilayer ceramic electronic devices have been increasingly used in communication servers and automotive electronic circuits. In the future, as servers and in-vehicle electronic circuits become more sophisticated, the amount of heat generated on circuit substrates will increase. And, as outside temperatures rise due to global warming, it may become difficult to dissipate that heat. Therefore, in the future, it is expected that performance higher than the current level will be required in terms of temperature stability of capacity.

Hereinafter, an exemplary embodiment will be described with reference to the accompanying drawings.

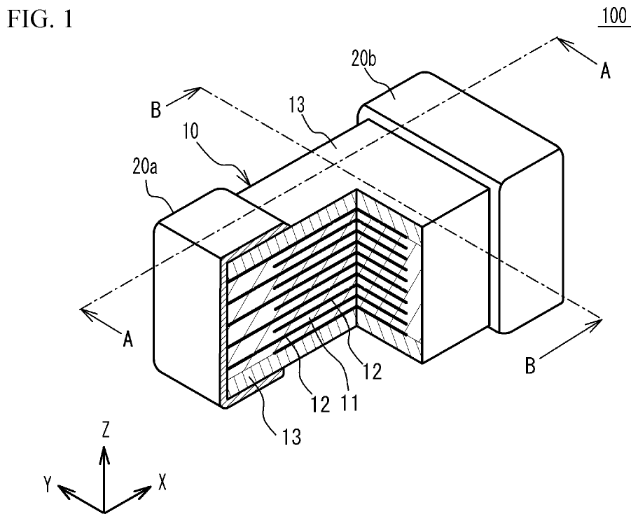

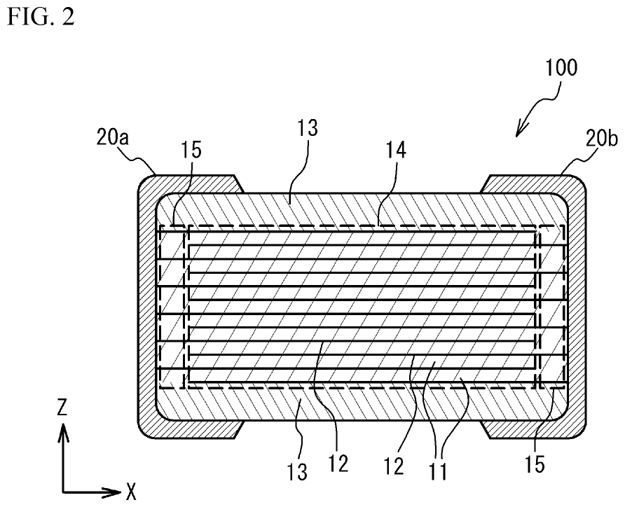

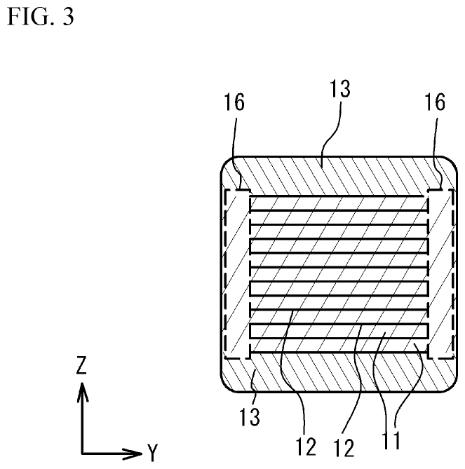

(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 1 to FIG. 3, a Z-axis direction (first direction) is a stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The multilayer chip 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 is the same as the main component of the dielectric layer 11. Note that the structure is not limited to the configurations illustrated in FIG. 1 to FIG. 3 as long as the internal electrode layer 12 is exposed on two different faces and electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The average thickness per layer of the internal electrode layer 12 in the Z-axis direction is, for example, 1.5 μm or less, 1.0 μm or less, or 0.7 μm or less. The thickness of the internal electrode layer 12 was determined by observing the cross section of the multilayer ceramic capacitor 100 with a SEM (scanning electron microscope), measuring the thickness at 10 points for each of the 10 different internal electrode layers 12, and calculating the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaTiO₃ (calcium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium titanate zirconate, calcium titanate zirconate, barium calcium titanate zirconate or the like. The thickness of the dielectric layer 11 is, for example, 10.0 μm or less, 5.0 μm or less, 3.0 μm or less, and 1.0 μm or less. The thickness of the dielectric layer 11 is determined by observing the cross section of the multilayer ceramic capacitor 100 with a SEM (scanning electron microscope), measuring the thickness of each of the 10 different dielectric layers 11 at 10 points, and calculating the average value of all measurement points.

Additives may be added to the dielectric layer 11. As additives to the dielectric layer 11, zirconium (Zr), magnesium (Mg), manganese (Mn), molybdenum (Mo), vanadium (V), chromium (Cr), rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

In recent years, multilayer ceramic capacitors have been increasingly used in communication servers and automotive electronic circuits. Such applications require multilayer ceramic capacitors to be reliable in high temperature operation up to 125 degrees C. Reliability here does not just mean a long service life under high temperatures, but also stable capacity over the wide temperature range from −55 degrees C. to 125 degrees C., which multilayer ceramic capacitors are exposed to. In order to guarantee such capacity stability, there are standards for temperature characteristics for multilayer ceramic capacitors. A typical example is the EIA standard. Typical multilayer ceramic capacitors for use in servers and vehicles are designed to meet the EIA standard X7R (capacity change rate from −55 degrees C. to 125 degrees C.±15% based on room temperature capacity). However, as servers and in-vehicle electronic circuits become more sophisticated in the future, the amount of heat generated on circuit boards will increase, and as outside temperatures rise due to global warming, it will become difficult to dissipate that heat. Because of this possibility, it is expected that performance higher than the current level will be required in terms of temperature stability of capacity. Electronic components that can be used at high temperatures are thought to be able to contribute to the SDGs by eliminating the need to use energy for cooling.

Regarding the capacity temperature stability of multilayer ceramic capacitors, there are two types: Class I (for temperature compensation, usually using a paraelectric material) and Class II (for high dielectric constant, usually using a ferroelectric material). Class I is a product group called NPO or C0G in which the temperature dependence of capacity is close to zero. In Class I, it is necessary to use a paraelectric material, and the dielectric constant remains at about 30, so products with high capacity density cannot be manufactured. Class II is a group of products using ferroelectric materials represented by barium titanate (BaTiO₃), and products with high capacity density can be manufactured due to the high dielectric constant of several hundreds to tens of thousands. In other words, a small capacitor with a large capacity can be made. However, this high dielectric constant differs from the dielectric constant of a paraelectric material and has the characteristic that the dielectric constant changes greatly depending on the temperature. A particular problem is a decrease in dielectric constant due to higher temperatures, that is, a decrease in product capacity. The above-mentioned United States Electronic Industries Association (EIA) standard stipulates this amount of change, and X7R, which exhibits a maximum capacity drop of only 15% even at 125 degrees C., is positioned as having the highest level of stable temperature characteristics among Class II MLCCs. Until now, the Ba/Ti ratio of barium titanate, which is the main phase, has been adjusted to around 1.000 in order to satisfy the X7R standard. This is related to the fact that the upper limit temperature of the X7R standard, 125 degrees C., is exactly the phase transition point of barium titanate crystal. Even in polycrystalline barium titanate, which is a ceramic, by approaching the ideal single-crystal Ba/Ti ratio, it is possible to benefit from the increase in relative dielectric constant that occurs at the phase transition point, thereby suppressing the capacity drop at 125 degrees C. becomes possible. The basic idea is the same for not only the X7R, which is guaranteed to be 125 degrees C., but also the X5R, which is guaranteed to be 85 degrees C.

Here, the Ba/Ti ratio is often expressed as the A/B ratio because it is not uncommon for the composition to be adjusted by replacing part or all of barium or titanium with other elements. Since BaTiO₃ has a perovskite crystal structure (general formula ABO₃), the “A/B ratio” is used to express the Ba/Ti ratio by including elements that replace the A site of barium and the B site of titanium.

For example, in Japanese Patent Application Publication No. 2014-172769 (hereinafter referred to as Patent Document 1), the ratio “z” of the sum of barium and calcium to the sum of titanium and zirconium that partially replaces titanium is defined as 0.995≤ z≤1.010. The ratio “z” is also another expression of A/B ratio. As described above, although there are variations in expression, in general multilayer ceramic capacitors, a value around 1.000 is adopted as described in Patent Document 1. How far the ratio “z” can deviate from 1.000 is often determined by electrical characteristics, such as temperature characteristics that deviate from regulations or life expectancy shortened. However, before that, a limit value is automatically determined when the ceramic structure has an abnormal shape or the sintering reaction does not occur sufficiently.

Conventionally, the limit for increasing barium (or A-site component) ratio from 1.000 is often set at 1.040 (for example, International Publication 2017/212978 hereinafter referred to as Patent Document 2). This is because if the ratio of barium is 1.040 or more, ceramics having barium titanate as a main phase cannot be sintered sufficiently in a temperature range where co-sintering with the internal electrodes can be performed. A multilayer ceramic capacitor full of pores and insufficiently sintered cannot be used as a product in terms of electrical properties or mechanical strength. Sintering can be achieved by adding a large amount of lithium-added glass as an auxiliary agent, but when an electric field is applied to such a sintered body, the lithium ions move through the sintered body, causing a current to flow. This is undesirable because it causes an increase in dielectric loss and a decrease in insulation properties of the multilayer ceramic capacitor. To date, no material has been reported that has sufficient dielectric properties and insulating properties for a multilayer ceramic capacitor by co-sintering barium titanate with a Ba/Ti ratio of 1.040 or more with a base metal internal electrode without using lithium.

In conventional material design, there is a limit to the capacity-temperature characteristics that can be designed due to the limit of the Ba/Ti ratio. As a result of intensive research by the present inventor, the present inventor succeeded in obtaining a sufficiently densified multilayer ceramic capacitor with the Ba/Ti ratio of 1.045 or more, which exceeds the conventional Ba/Ti ratio limit, by using a unique additive composition. The present inventor has found, in the high Ba/Ti ratio region, EIA standard X7E (±4.7%), X7D (±3.3%), X7C (±2.2%) with much higher capacity temperature stability than X7R (±15%) can be achieved.

There have also been reports in past patent documents regarding the design of dielectric materials with temperature stability exceeding that of X7R. For example, Japanese Patent Application Publication No. H03-173107 hereinafter referred to as Patent Document 3 reports that a dielectric material of X7F (±7.5%) can be obtained by adding predetermined amounts of Nb₂O₅, Gd₂O₃, and ZnO to barium titanate. Furthermore, in Japanese Patent Application Publication No. H06-60721 hereinafter referred to as Patent Document 4, temperature stability of X7P (±10%) or better is achieved by adding a predetermined amount of Nb₂O₅, Ta₂O₅, MO (M is Co, Zn, Mg, Ni, or Mn) to barium titanate. However, all of the samples were thick bulk bodies with a thickness on the order of mm (millimeter), and therefore the electric field strength applied to the dielectric when a standard input signal of 1.0 V was applied was extremely small. On the other hand, the layer thickness of an actual general multilayer ceramic capacitor is as thin as μm (micrometer) order, and the electric field strength is much larger than that of the bulk body reported in Patent Documents 3 and 4. As the electric field strength increases, the polarization changes significantly and the amount of capacity change also increases. Therefore, when the materials shown in Patent Documents 3 and 4 are applied to a multilayer ceramic capacitor, stable temperature characteristics exceeding the EIA standard X7R is not guaranteed. Furthermore, the sintered bodies in these reports were fired in the atmosphere. In base metal electrode MLCC (BME-MLCC), which is co-sintered with nickel electrodes, copper electrodes, or the like, the electrode is fired in a reductive atmosphere containing hydrogen so that the electrode is not oxidized. At this time, unless the material is designed to be resistant to reduction, barium titanate will be easily reduced and lose its insulating properties, rendering it useless as a capacitor. The above-mentioned material design centered on Nb₂O₅ is easily reduced and converted into a semiconductor. From the viewpoint of the above two points (electric field strength and reduction resistance), the temperature stable materials of X7P or better mentioned in Patent Documents 3 and 4 are unsuitable as materials for multilayer ceramic capacitors using base metals as internal electrodes.

As a material design for improving the capacity-temperature characteristics of multilayer ceramic capacitors, research has recently been reported on relaxer materials in which bismuth-containing perovskites (BiFeO₃ and BiTiO₃) are reacted with other perovskites such as SrTiO₃ and CaTiO₃. For example, Internal Publication No. 2021/229919 hereinafter referred to as Patent Document 5 and U.S. Pat. No. 9,847,176 hereinafter referred to as Patent Document 6 are applicable. In such materials, there is a region (supernormal dielectric region) in which the dielectric constant is stable at a higher temperature than the peak of the dielectric constant, and this region can be used for capacity temperature stability. However, there is a problem that bismuth perovskite decomposes and evaporates during reduction firing and comes off from the multilayer ceramic capacitor. Even if the coming off is somehow stopped, if an atmosphere that does not oxidize the internal electrodes from a thermodynamic/equilibrium perspective is selected, bismuth will also be reduced and become metal, making it impossible to maintain insulation. Therefore, it is suitable for multilayer ceramic capacitors that use noble metal electrodes and are fired in the atmosphere, but is not suitable for base metal internal electrodes that are fired in a reducing atmosphere.

There have also been reports of materials that effectively utilize the superdielectric region without relying on bismuth and achieve the characteristics of a multilayer ceramic capacitor with internal electrodes made of base metal (for example, Japanese Patent Application Publication No. 2001-143955 hereinafter referred to as Patent Document 7 and Japanese Patent Application Publication No. H11-322416 hereinafter referred to as Patent Document 8). This is a method of doping barium titanate in large amounts with additives that significantly lower the phase transition temperature of barium titanate, such as gadolinium, to shift the phase transition point to below 0° C. and designing the material to use the electrical properties of the superparaelectric region above room temperature. This method is superior to the above-mentioned bismuth-based materials in that the material can be co-sintered with base metal electrodes. However, even with this method, the temperature characteristics could not be improved to the level of X7E (±4.7%), X7D (±3.3%), and X7C (±2.2%). This is because these designs are done within the limits of the conventional A/B ratios mentioned above (0.990≤A/B ratio≤1.030 in Patent Document 7 and 1.000<A/B ratio≤1.035 in Patent Document 8).

The multilayer ceramic capacitor 100 according to the present embodiment has a configuration with excellent capacity temperature stability, even for communication servers and in-vehicle electronic circuits, where management of heat generated in circuits is becoming stricter. The details will be explained below.

Specifically, as described above, the dielectric layer 11 includes a main component. The main component has a perovskite structure represented by the general formula ABO₃, contains titanium, and contains at least one of barium and calcium. Further, the dielectric layer 11 includes a first subcomponent, a second subcomponent, and a third subcomponent. In the main component, the molar ratio of the sum of barium and calcium to titanium is 1.045 or more and 1.100 or less. The molar ratio of the sum of barium and calcium to titanium is hereinafter referred to as the (Ba+Ca)/Ti ratio. By setting the (Ba+Ca)/Ti ratio to such a high value, excellent temperature stability of capacity can be achieved. From the viewpoint of achieving better temperature stability of capacity, the (Ba+Ca)/Ti ratio is preferably 1.045 or more, more preferably 1.100 or more.

On the other hand, if the (Ba+Ca)/Ti ratio is high, the sinterability may deteriorate and the amount of shrinkage will decrease, which may cause the dimensions of the multilayer ceramic capacitor 100 to become larger than specified. Therefore, the (Ba+Ca)/Ti ratio is preferably 1.100 or less, more preferably 1.060 or less.

Next, the first subcomponent contains 3 mol or more of a rare earth element per 100 mol of titanium in the dielectric layer 11. Thereby, grain growth in the dielectric layer 11 can be suppressed, dielectric loss tangent tan 8 can be reduced, and dielectric loss can be reduced. From the viewpoint of suppressing grain growth in the dielectric layer 11, the first subcomponent preferably contains 3.0 mol or more of the rare earth element per 100 mol of titanium in the dielectric layer 11, and preferably contains 6.0 mol or more of the rare earth element. Note that rare earth elements are not particularly limited. The rare earth element is such as scandium, yttrium, cerium, neodymium, europium, gadolinium, terbium, dysprosium, holmium, erbium, or ytterbium.

Next, the first subcomponent contains 6 mol or less of the rare earth element per 100 mol of titanium in the dielectric layer 11. Thereby, it is not necessary to suppress grain growth excessively, and insufficient densification in the dielectric layer 11 can be suppressed. From the viewpoint of suppressing insufficient densification in the dielectric layer 11, the first subcomponent preferably contains 6.0 mol or less of the rare earth element per 100 mol of titanium in the dielectric layer 11, and preferably contains 5.0 mol or less of the rare earth element.

Next, the second subcomponent contains 3 mol or more of manganese per 100 mol of titanium in the dielectric layer 11. Thereby, it is not necessary to suppress grain growth excessively, and insufficient densification in the dielectric layer 11 can be suppressed. From the viewpoint of suppressing insufficient densification in the dielectric layer 11, the second subcomponent preferably contains 3.0 mol or more of manganese, and preferably contains 5.0 mol or more of manganese per 100 mol of titanium in the dielectric layer 11.

Next, the second subcomponent contains 7 mol or less of manganese per 100 mol of titanium in the dielectric layer 11. Thereby, the reaction between manganese and the internal electrode layer 12 is suppressed, and it is possible to suppress the internal electrode layer 12 from becoming an insulator. From the viewpoint of suppressing the internal electrode layer 12 from becoming an insulator, the second subcomponent preferably contains 7.0 mol or less of manganese, and contains 5.0 mol or less of manganese per 100 mol of titanium in the dielectric layer 11.

Next, the third subcomponent contains 0.6% by weight or more of borosilicate glass (B₂O₃—SiO₂-based glass) with respect to the entire dielectric layer 11. Thereby, even if the (Ba+Ca)/Ti ratio is high, sintering can be promoted and insufficient densification of the dielectric layer 11 can be suppressed. From the viewpoint of suppressing insufficient densification of the dielectric layer 11, the third subcomponent preferable contains 1.0% by weight or more of borosilicate glass, and 2.0% by weight or more of borosilicate glass with respect to the entire dielectric layer 11.

Next, the third subcomponent contains 2.4% by weight or less of borosilicate glass with respect to the entire dielectric layer 11. This prevents the borosilicate glass from becoming excessive, and prevents the metal components of the internal electrode layer 12 from being carried and dissipated by the borosilicate glass whose viscosity has been reduced (liquefied) during the sintering process. From the viewpoint of suppressing the dissipation of the metal component of the internal electrode layer 12, the third subcomponent preferably contains 2.4% by weight or less of borosilicate glass with respect to the entire dielectric layer 11, and more preferably contains 2.0% by weight or less of borosilicate glass with respect to the entire dielectric layer 11.

Note that if the borosilicate glass contained in the third subcomponent contains less boron, the function of the borosilicate glass as a sintering aid will be weakened, and there is a risk that the dielectric layer 11 will be insufficiently densified. Therefore, in the third subcomponent, the molar ratio of boron to silicon is preferably 0.4 or more. On the other hand, if the third subcomponent contains a large amount of boron in the borosilicate glass, the viscosity of the slurry for firing the dielectric layer 11 will increase, and there is a possibility that it will not be possible to form a ceramic green sheet. Therefore, in the third subcomponent, the molar ratio of boron to silicon is preferably 0.8 or less.

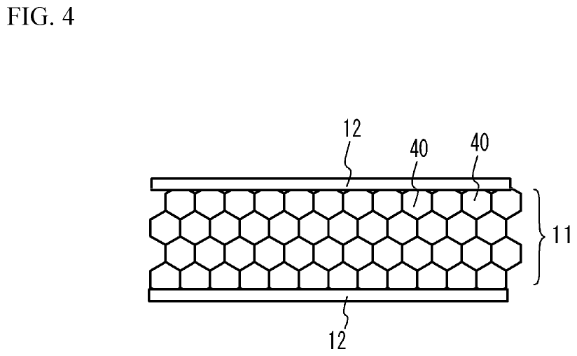

FIG. 4 is a cross-sectional view schematically illustrating dielectric grains in the dielectric layer 11. As illustrated in FIG. 4, each of the dielectric layers 11 has a structure in which a plurality of dielectric grains 40 are sintered. If the average grain diameter of the dielectric grains 40 is large, there is a possibility that the lifetime will be shortened. Therefore, it is preferable to set an upper limit on the average grain diameter of the dielectric grains 40. In this embodiment, the average grain diameter of the dielectric grains 40 is preferably 150 nm or less. On the other hand, if the average grain diameter of the dielectric grains 40 is small, the dielectric constant may become too small. Therefore, it is preferable to set a lower limit on the average grain diameter of the dielectric grains 40. In this embodiment, the average grain diameter of the dielectric grains 40 is preferably 50 nm or more.

Note that the average grain diameter of the dielectric grains 40 can be measured as follows. Specifically, the multilayer ceramic capacitor 100 is cut parallel to the end face on which the external electrode is formed, and the cross section is polished. The cross section corresponds to a YZ cross section. The grain diameter of the dielectric grains is measured based on a cross section image of the dielectric layer taken with a scanning electron microscope (SEM) for the cross section. Based on the SEM image, the maximum lengths of the dielectric grains in the stacking direction is defined as the grains diameters, and the arithmetic mean value of each measured grain diameter is defined as the average grain diameter of the dielectric grains. The polishing position here is set in a central region divided into five equal parts in the X-axis direction from the end faces of both external electrodes so as to be near the center.

Since the dielectric layer 11 according to the present embodiment achieves excellent temperature stability of capacity, the multilayer ceramic capacitor 100 can satisfy, for example, temperature characteristics X7E, X7D, or X7C in the EIA standard.

Further, by using a ferroelectric material such as barium titanate as the main component of the dielectric layer 11 according to this embodiment, the dielectric layer 11 can achieve a relative dielectric constant of 600 or more.

Furthermore, since the dielectric loss of the dielectric layer 11 can be suppressed, it is possible to achieve a dielectric loss tangent tan 8 of 0.01 or less, for example.

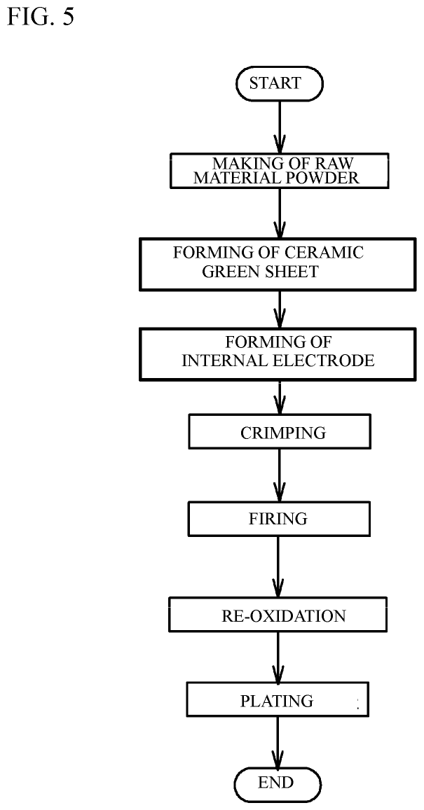

Next, a description will be given of a manufacturing method of the multilayer ceramic capacitors 100. FIG. 5 illustrates a manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

A predetermined additive compound is added to the obtained dielectric powder according to the purpose. As additives to the dielectric layer 11, zirconium, hafnium, magnesium, manganese, molybdenum, vanadium, chromium, rare earth elements (scandium, cerium, neodymium, yttrium, samarium, europium, gadolinium, terbium, dysprosium, holmium, erbium, thulium and ytterbium) or an oxide of cobalt, nickel, lithium, boron, sodium, potassium or silicon, or a glass including cobalt, nickel, lithium, boron, sodium, potassium or silicon.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

The obtained dielectric material includes the main component, the first subcomponent, the second subcomponent, and the third subcomponent. The main component has a perovskite structure represented by the general formula ABO₃, contains titanium, contains at least one of barium and calcium, and has a molar ratio of the sum of barium and calcium to titanium of 1.045 or more and 1.100 or more. BaCO₃, CaO, CaCO₃ or the like can be used to adjust the molar ratio of the sum of barium and calcium to titanium. The first subcomponent contains the rare earth element in an amount of 3 mol or more and 6 mol or less per 100 mol of titanium in the dielectric material. The second subcomponent includes manganese in an amount of 3 mol or more and 7 mol or less per 100 mol of titanium in the dielectric material. The third subcomponent contains borosilicate glass in an amount of 0.6% by weight or more and 2.4% by weight or less with respect to the entire dielectric material.

Next, a dielectric pattern material for forming the side margin 16 is prepared. The dielectric pattern material includes the main component ceramic powder of the side margins 16. As the main component ceramic powder, for example, the main component ceramic powder of the dielectric material can be used. Predetermined additive compounds are added depending on the purpose.

(Forming process of green sheet) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. The process is omitted in FIG. 5.

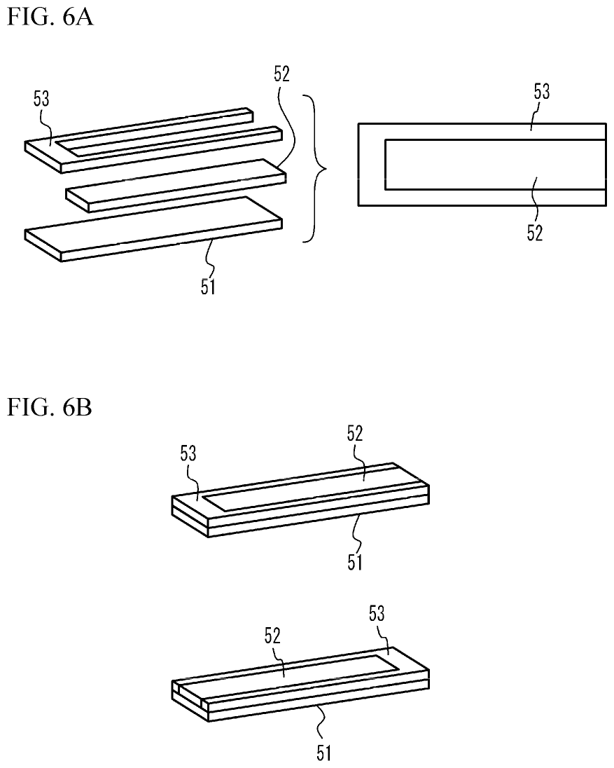

(Forming process of internal electrode pattern) Next, as illustrated in FIG. 6A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 6A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 6B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. For example, the number of the internal electrode pattern 52 is 100 to 500.

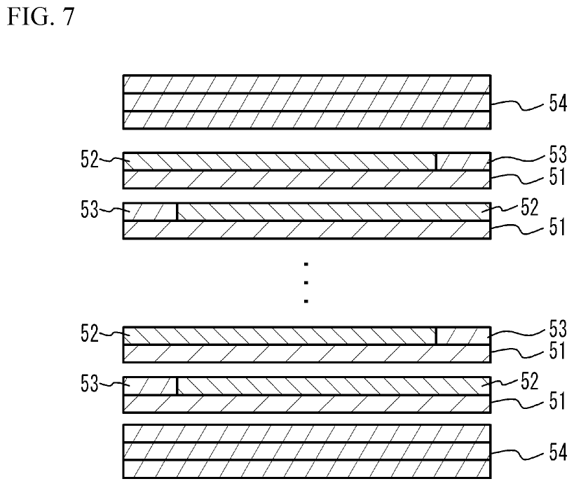

(Crimping process) Next, as illustrated in FIG. 7, a predetermined number (for example, 2 to 10) cover sheet 54 are stacked on the stacked stack units and under the stacked stack units. After that, the stacked structure is thermally crimped. The above-mentioned dielectric material or the above-mentioned dielectric pattern material can be used as the ceramic material of the cover sheets 54.

(Firing process) The binder is removed from the resulting ceramic multilayer structure in N₂ atmosphere. After that, a metal paste to be the base layer of the external electrodes 20a and 20b is applied to the resulting ceramic multilayer by a dipping or the like. The resulting ceramic multilayer structure is fired in a reducing atmosphere with an oxygen partial pressure of 10-5 to 10-8 atm in a temperature of 1150° C. to 1250° ° C. for 5 minutes to 10 hours.

(Re-oxidation process) In order to return oxygen to the partially reduced main phase barium titanate of the dielectric layer 11 fired in a reducing atmosphere, N₂ and water vapor are mixed at about 1000° ° C. to an extent that the internal electrode layer 12 is not oxidized, heat treatment may be performed in gas or in the atmosphere at 500° C. to 700° C. This process is called a re-oxidation process.

(Plating process) After that, metal layers such as copper, nickel, and tin may be formed on the base layer of the external electrodes 20a and 20b by plating. Thus, the multilayer ceramic capacitor 100 is manufactured.

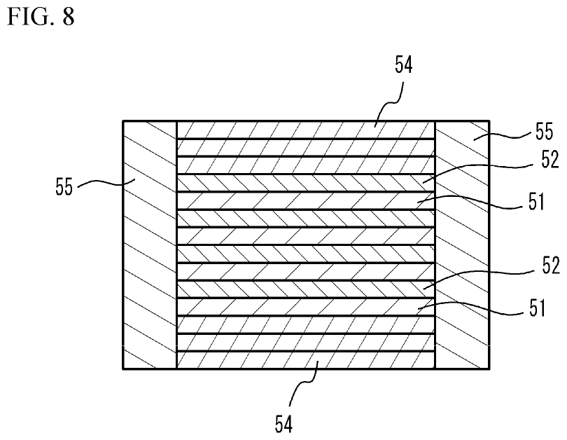

The side margin portion may be attached or coated on the side face of the multilayer portion. Specifically, as illustrated in FIG. 8, the multilayer portion is obtained by alternately stacking the ceramic green sheets 51 and the internal electrode patterns 52 having the same width as the ceramic green sheets 51. Next, a sheet formed of the dielectric pattern paste may be attached as a side margin portion 55 to the side face of the multilayer portion.

Note that in the above, the base layer for the external electrode and the ceramic multilayer structure are fired at the same time, but the method is not limited thereto. For example, after firing the ceramic multilayer structure, a paste of Ni, Cu, or Ag may be applied and baked, or terminal electrodes may be formed by plating or sputtering techniques.

Further, although the above embodiment is applied to a multilayer ceramic capacitor having two terminal electrodes, it may also be applied to a multilayer ceramic capacitor having three or more terminals. In particular, since three-terminal capacitors that are generally used for high frequencies with low ESL are required to have sufficiently low ESR, the dielectric layer described in the above embodiment is also suitable for three-terminal capacitors.

The multilayer ceramic capacitor 100 according to the above embodiment has a relatively low relative dielectric constant in the category of Class II capacitors, so electrostrictive deformation when an alternating current electric field is input is small. When a Class II capacitor is mounted on a substrate, periodic electrostrictive deformation may be amplified by the deflection of the substrate and generate audible noise, which may be a problem. However, when the multilayer ceramic capacitor 100 according to the above embodiment is used, it is possible to design products that suppress electrostrictive noise.

Note that in each of the above embodiments, a multilayer ceramic capacitor has been described as an example of a multilayer ceramic electronic device, but the present invention is not limited thereto. For example, other multilayer ceramic electronic devices such as varistors or thermistors may be used.

### EXAMPLES

(Example 1) Powders of barium carbonate (BaCO₃), holmium oxide (Ho₂O₃), and manganese carbonate (MnCO₃) were added to barium titanate (BaTiO₃) powder with an average particle diameter of 100 nm. The (Ba+Ca)/Ti ratio was set to 1.045. In Example 1, since Ca was not added, the (Ba+Ca)/Ti ratio is the Ba/Ti ratio. With respect to 100 mol of titanium, the amount of holmium added was 6.0 mol, and the amount of manganese added was 5.0 mol. Furthermore, borosilicate glass was added to form a dielectric material. The amount of borosilicate glass added to the total weight of the dielectric material was 2.4 wt %.

These were mixed with ethanol, toluene, and PVB (polyvinyl butyral) resin. Mixing was performed using a ball mill using YSZ (yttria stabilized zirconia) balls to prepare a dielectric slurry. This slurry was formed into a ceramic green sheet with a thickness of 4 μm using a die coater. After drying this ceramic green sheet, nickel paste was printed to form an internal electrode pattern. Eleven layers of the obtained stack units were stacked, and thick layers of ceramic green sheets on which no internal electrode pattern was formed were press-bonded on top and bottom, and then cut into small pieces. Thereafter, Ni paste was dipped on the two end faces as a conductive paste for external electrodes, and degreasing was performed in nitrogen gas. The degreased piece was sintered by firing at 1270 degrees C. for 2 hours in a N₂—H₂-H₂O mixed gas controlled to have an oxygen partial pressure that would not oxidize nickel, thereby producing a multilayer ceramic capacitor.

The size of the manufactured multilayer ceramic capacitor was 1005 shape (1.0 mm×1.0 mm×0.5 mm). The thickness of each dielectric layer was 3.2 μm. Thereafter, heat treatment was performed at 860 degrees C. for 2 hours in a mixed gas of nitrogen and several ppm of oxygen, and reoxidation treatment was performed to compensate for oxygen ions lost from the barium titanate crystal.

(Example 2) In Example 2, the amount of holmium added was 4.0 mol with respect to 100 mol of titanium. The amount of borosilicate glass added to the total weight of the dielectric material was 1.3 wt %. Other conditions were the same as in Example 1.

(Example 3) In Example 3, the amount of holmium added was 3.0 mol with respect to 100 mol of titanium. The amount of borosilicate glass added to the total weight of the dielectric material was 1.3 wt %. Other conditions were the same as in Example 1.

(Example 4) In Example 4, calcium carbonate (CaCO₃) was added instead of barium carbonate (BaCO₃). The (Ba+Ca)/Ti ratio was 1.045. The amount of holmium added was 4.0 mol with respect to 100 mol of titanium. The amount of borosilicate glass added to the total weight of the dielectric material was 1.3 wt %. Other conditions were the same as in Example 1.

(Example 5) In Example 5, the (Ba+Ca)/Ti ratio was set to 1.100. Other conditions were the same as in Example 1.

(Example 6) In Example 6, calcium carbonate (CaCO₃) was added instead of barium carbonate (BaCO₃). The (Ba+Ca)/Ti ratio was set to 1.100. Other conditions were the same as in Example 1.

(Example 7) In Example 7, the amount of manganese added was 3.0 mol with respect to 100 mol of titanium. Other conditions were the same as in Example 1.

(Example 8) In Example 8, the amount of manganese added was 7.0 mol with respect to 100 mol of titanium. The amount of borosilicate glass added to the total weight of the dielectric material was 1.3 wt %. Other conditions were the same as in Example 1.

(Example 9) In Example 9, the average particle diameter of the barium titanate powder was 150 nm. Other conditions were the same as in Example 1.

(Example 10) In Example 10, the average particle diameter of the barium titanate powder was 150 nm. The (Ba+Ca)/Ti ratio was set to 1.100. Other conditions were the same as in Example 1.

(Example 11) In Example 11, the average particle diameter of the barium titanate powder was 150 nm. Calcium carbonate (CaCO₃) was added instead of barium carbonate (BaCO₃). The (Ba+Ca)/Ti ratio was set to 1.100. Other conditions were the same as in Example 1.

(Comparative Example 1) In Comparative Example 1, the (Ba+Ca)/Ti ratio was set to 1.010. With respect to 100 mol of titanium, the amount of holmium added was 1.0 mol, and the amount of manganese added was 0.5 mol. Li—Si—Al glass powder was used instead of borosilicate glass. The amount of the glass added to the total weight of the dielectric material was 0.8 wt %. Other conditions were the same as in Example 1.

(Comparative Example 2) In Comparative Example 2, the amount of holmium added was 1.0 mol and the amount of manganese added was 0.5 mol, with respect to 100 mol of titanium. Li—Si—Al glass powder was used instead of borosilicate glass. The amount of the glass added to the total weight of the dielectric material was 0.8 wt %. Other conditions were the same as in Example 1.

(Comparative Example 3) In Comparative Example 3, the (Ba+Ca)/Ti ratio was set to 1.040. The amount of holmium added was 4.0 mol with respect to 100 mol of titanium. The amount of borosilicate glass added to the total weight of the dielectric material was 1.3 wt %. Other conditions were the same as in Example 1.

(Comparative Example 4) In Comparative Example 4, the (Ba+Ca)/Ti ratio was set to 1.200. The amount of holmium added was 4.0 mol with respect to 100 mol of titanium. The amount of borosilicate glass added to the total weight of the dielectric material was 1.3 wt %. Other conditions were the same as in Example 1.

(Comparative Example 5) In Comparative Example 5, the amount of holmium added was 2.0 mol with respect to 100 mol of titanium. The amount of borosilicate glass added to the total weight of the dielectric material was 1.3 wt %. Other conditions were the same as in Example 1.

(Comparative Example 6) In Comparative Example 6, the amount of holmium added was 7.0 mol with respect to 100 mol of titanium. The amount of borosilicate glass added to the total weight of the dielectric material was 1.3 wt %. Other conditions were the same as in Example 1.

(Comparative Example 7) In Comparative Example 7, the amount of holmium added was 4.0 mol and the amount of manganese added was 2.0 mol, with respect to 100 mol of titanium. The amount of borosilicate glass added to the total weight of the dielectric material was 1.3 wt %. Other conditions were the same as in Example 1.

(Comparative Example 8) In Comparative Example 8, the amount of holmium added was 4.0 mol and the amount of manganese added was 8.0 mol, with respect to 100 mol of titanium. The amount of borosilicate glass added to the total weight of the dielectric material was 1.3 wt %. Other conditions were the same as in Example 1.

(Comparative Example 9) In Comparative Example 9, the amount of holmium added was 4.0 mol with respect to 100 mol of titanium. The amount of borosilicate glass added to the total weight of the dielectric material was 0.5 wt %. Other conditions were the same as in Example 1.

(Comparative Example 10) In Comparative Example 10, the amount of holmium added was 4.0 mol with respect to 100 mol of titanium. The amount of borosilicate glass added to the total weight of the dielectric material was 2.5 wt %. Other conditions were the same as in Example 1.

Table 1 shows the conditions of Examples 1 to 11 and Comparative Examples 1 to 10.

TABLE 1

| | BaTiO₃ | | | | | BORO- |
|---|---|---|---|---|---|---|
| | PARTICLE | | | AMOUNT | AMOUNT | SILICATE |
| | DIAMETER | ADDITIVE | | OF Ho | OF Mn | GLASS |
| | [nm] | IN A SITE | (Ba + Ca)/Ti | [mol] | [mol] | [wt %] |
| COMPARATIVE | 100 | Ba | 1.010 | 1.0 | 0.5 | 0.8 |
| EXAMPLE 1 | | | | | | |
| COMPARATIVE | 100 | Ba | 1.045 | 1.0 | 0.5 | 0.8 |
| EXAMPLE 2 | | | | | | |
| COMPARATIVE | 100 | Ba | 1.040 | 4.0 | 5.0 | 1.3 |
| EXAMPLE 3 | | | | | | |
| COMPARATIVE | 100 | Ba | 1.200 | 4.0 | 5.0 | 1.3 |
| EXAMPLE 4 | | | | | | |
| COMPARATIVE | 100 | Ba | 1.045 | 2.0 | 5.0 | 1.3 |
| EXAMPLE 5 | | | | | | |
| COMPARATIVE | 100 | Ba | 1.045 | 7.0 | 5.0 | 1.3 |
| EXAMPLE 6 | | | | | | |
| COMPARATIVE | 100 | Ba | 1.045 | 4.0 | 2.0 | 1.3 |
| EXAMPLE 7 | | | | | | |
| COMPARATIVE | 100 | Ba | 1.045 | 4.0 | 8.0 | 1.3 |
| EXAMPLE 8 | | | | | | |
| COMPARATIVE | 100 | Ba | 1.045 | 4.0 | 5.0 | 0.5 |
| EXAMPLE 9 | | | | | | |
| COMPARATIVE | 100 | Ba | 1.045 | 4.0 | 5.0 | 2.5 |
| EXAMPLE 10 | | | | | | |
| EXAMPLE 1 | 100 | Ba | 1.045 | 6.0 | 5.0 | 2.4 |
| EXAMPLE 2 | 100 | Ba | 1.045 | 4.0 | 5.0 | 1.3 |
| EXAMPLE 3 | 100 | Ba | 1.045 | 3.0 | 5.0 | 1.3 |
| EXMPLE 4 | 100 | Ca | 1.045 | 4.0 | 5.0 | 1.3 |
| EXAMPLE 5 | 100 | Ba | 1.100 | 6.0 | 5.0 | 2.4 |
| EXAMPLE 6 | 100 | Ca | 1.100 | 6.0 | 5.0 | 2.4 |
| EXAMPLE 7 | 100 | Ba | 1.045 | 6.0 | 3.0 | 2.4 |
| EXAMPLE 8 | 100 | Ba | 1.045 | 6.0 | 7.0 | 1.3 |
| EXAMPLE 9 | 150 | Ba | 1.045 | 6.0 | 5.0 | 2.4 |
| EXAMPLE 10 | 150 | Ba | 1.100 | 6.0 | 5.0 | 2.4 |
| EXAMPLE 11 | 150 | Ca | 1.100 | 6.0 | 5.0 | 2.4 |

The multilayer ceramic capacitors of Examples 1 to 11 and Comparative Examples 1 to 10 were left standing in a constant temperature bath at 150° C. for 2 hours, then taken out to room temperature, and after 24 hours, the capacity and tan 8 were measured using an LCR meter at 1 kHz and 1 Vrms. Thereafter, the multilayer ceramic capacitors were placed in a chamber for measuring temperature characteristics, and the capacity and tan 8 at each temperature were measured while increasing the temperature from −55° C. to 150° C. At this time, a multilayer ceramic capacitor that is insufficiently densified by sintering has many pores in its element body and is affected by the outside air and dew condensation, and exhibits an abnormally large value of tan 8 at around 0° C. In this test, those in which such an abnormality in tan 8 was observed were judged to be insufficiently densified. This is because a sintered body whose dielectric properties are not sufficiently densified to be affected by the outside air cannot be used as an electronic component.

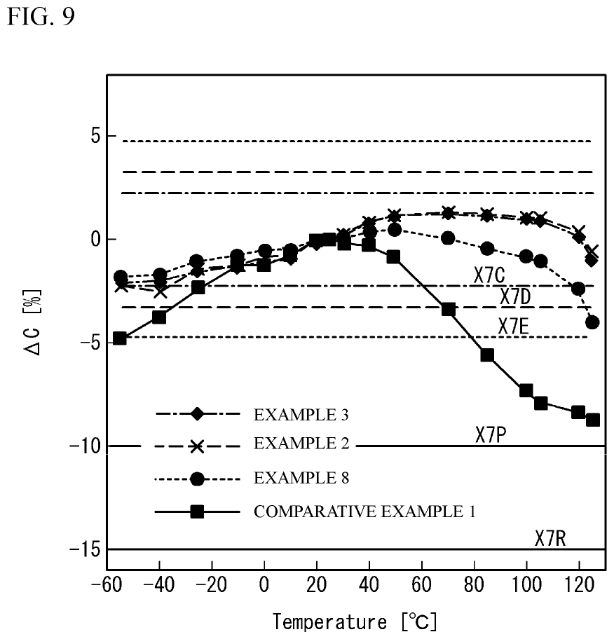

For the capacity thus measured, the rate of change in capacity was calculated at each temperature based on the capacity value at 25° C., and it was determined whether the amount of change corresponded to any of the Class II EIA standards shown in Table 2. For standards starting with X7 (meaning −55° C. to 125° C.), the largest capacity change is in most cases the capacity values at −55° C. and 125° C., which are the farthest vertically from the standard room temperature. Therefore, this amount of change is listed in Table 3, and the corresponding EIA standard is also listed. However, there are rare cases where the rate of change in capacity between −55° C. and 125° C. exceeds the rate of change in capacity between −55° C. and 125° C. In such a case, the values at −55° C. and 125° C. may seem to satisfy the specifications, but in reality, the upper and lower limits of the rate of change of the specifications may be exceeded in the intermediate temperature range. Therefore, in Table 3, in addition to the capacity change rates at −55° C. and 125° C., the absolute value of the maximum capacity change rate is also listed. For example, Example 2 shows that there is a capacity change at intermediate temperatures that is larger in absolute value than the capacity change rates at −55° C. and 125° C. For example, from FIG. 9, it can be seen that the intermediate temperature is −40° C. Note that FIG. 9 is a capacity change rate plot based on 25° C. The determination of which EIA standard it falls under was made after taking into account all such changes in the intermediate temperature range.

TABLE 2

| | | | | | MAX |
|---|---|---|---|---|---|
| | | | | | torelance for |
| | Low | | High | | capacitance |
| First | Temperature | Numerical | Temperature | Last | change |
| Symbol | (° C.) | Symbol | (° C.) | Symbol | (%) |
| X | −55 | 2 | +45 | A | ±1.0 |
| Y | −30 | 4 | +65 | B | ±1.5 |
| Z | +10 | 5 | +85 | C | ±2.2 |
| | | 6 | +105 | D | ±3.3 |
| | | 7 | +125 | E | ±4.7 |
| | | 8 | +150 | F | ±7.5 |
| | | 9 | +200 | P | ±10 |
| | | | | R | ±15 |
| | | | | S | ±22 |

TABLE 3

| | | RELATIVE | | | | |
|---|---|---|---|---|---|---|
| | | DIELECTRIC | ΔC −55° | ΔC 125° | MAX | |
| | tanδ | CONSTANT | C. | C. | \|ΔC\| | EIA |
| | [%] | (εᵣ) | [%] | [%] | [%] | STANDARD |
| COMPARATIVE | 2.9 | 1180 | −4.8 | −8.8 | 8.8 | X7R(P) |
| EXAMPLE 1 | | | | | | |
| COMPARATIVE | INSUFFICIENTLY DENSIFIED | | | | | |
| EXAMPLE 2 | | | | | | |
| COMPARATIVE | 2.1 | 910 | −6.3 | 3.8 | 6.3 | X7F |
| EXAMPLE 3 | | | | | | |
| COMPARATIVE | INSUFFICIENTLY DENSIFIED | | | | | |
| EXAMPLE 4 | | | | | | |
| COMPARATIVE | 1.8 | 890 | −5.4 | 2.6 | 5.4 | X7F |
| EXAMPLE 5 | | | | | | |
| COMPARATIVE | INSUFFICIENTLY DENSIFIED | | | | | |
| EXAMPLE 6 | | | | | | |
| COMPARATIVE | INSUFFICIENTLY DENSIFIED | | | | | |
| EXAMPLE 7 | | | | | | |
| COMPARATIVE | OPEN FAULT | | | | | |
| EXAMPLE 8 | | | | | | |
| COMPARATIVE | INSUFFICIENTLY DENSIFIED | | | | | |
| EXAMPLE 9 | | | | | | |
| COMPARATIVE | OPEN FAULT | | | | | |
| EXAMPLE 10 | | | | | | |
| EXAMPLE 1 | 0.7 | 681 | −2.9 | −2.4 | 2.4 | X7D |
| EXAMPLE 2 | 0.7 | 804 | −2.3 | −0.6 | 2.5 | X7D |
| EXAMPLE 3 | 0.8 | 706 | −2.1 | −1.0 | 2.1 | X7C |
| EXAMPLE 4 | 0.7 | 750 | −2.1 | −3.1 | 3.1 | X7D |
| EXAMPLE 5 | 0.8 | 658 | −2.8 | −0.1 | 2.8 | X7D |
| EXAMPLE 6 | 0.6 | 649 | −1.6 | −2.1 | 2.1 | X7C |
| EXAMPLE 7 | 0.8 | 827 | −2.9 | −0.1 | 2.9 | X7D |
| EXAMPLE 8 | 0.7 | 740 | −1.8 | −4.0 | 4.0 | X7E |
| EXAMPLE 9 | 0.9 | 810 | −2.9 | −0.6 | 2.9 | X7D |
| EXAMPLE 10 | 0.9 | 771 | −3.0 | 2.1 | 3.0 | X7D |
| EXAMPLE 11 | 0.7 | 765 | −1.9 | 0.0 | 1.9 | X7C |

From the results in Table 3, regarding the rate of change in capacity from −55° C. to 125° C. and the EIA standard, it can be seen that any of Examples 1 to 11 has characteristics of extremely high temperature stability such as X7E (±4.7%), X7D (±3.3%), X7C (±2.2%). Further, the relative dielectric constant and dielectric loss (tan 8) at room temperature are also shown. It can be seen that the multilayer ceramic capacitors of Examples 1 to 11 have a high dielectric constant of 600 or more and a low dielectric loss of 1.0% or less. Of course, there are so-called Class I capacitors using paraelectric materials that only have good temperature characteristics and low loss, but the permittivity of these paraelectric materials is generally 30 or less which is low, and high capacity cannot be achieved. The multilayer ceramic capacitors of Examples 1 to 11 are different from Class I capacitors in that they are high dielectric constant Class II capacitors that enable high-capacity products, but they also achieve good temperature characteristics and low loss.

Note that the results of Examples 4, 6, and 11 indicate that calcium may be used instead of barium as the A-site element. This is because a dense sintered body is obtained by co-sintering with the internal electrode layer, and good dielectric properties are obtained.

From the results of Examples 1 to 11, it was found that good results were obtained when the average particle diameter of the barium titanate powder was 150 nm or less. This is because the smaller the diameter, the smoother the ceramic green sheet will be with fewer defects when the barium titanate powder is formed into a thin ceramic green sheet on the order of several μm. However, if the ceramic green sheet is thick, the effect of slight irregularities on the surface of the sheet will be reduced, so a ceramic green sheet with a particle diameter of 200 nm or more may be used.

On the other hand, in Comparative Examples 1 to 10, none of X7E (±4.7%), X7D (±3.3%), and X7C (±2.2%) were satisfied, or the densification was insufficient. Or, the opening has become defective.

In Comparative Example 1, the dielectric loss was large compared to the relative dielectric constant. This is thought to be due in part to the use of glass containing lithium.

In Comparative Example 2, the (Ba+Ca)/Ti ratio was set to 1.045, but densification was insufficient even though low-temperature sintering glass containing lithium was used. This is thought to be due to the small amount of manganese added.

In Comparative Example 3, the (Ba+Ca)/Ti ratio is less than 1.045. In this case, it is thought that the grain growth of barium titanate during sintering could not be completely stopped and the solid solution of the additive elements progressed, resulting in the deterioration of the temperature characteristics of the capacity. Although the temperature characteristics are better than those with a general composition such as Comparative Example 1, the EIA standard that was satisfied was only X7F, and X7E was not satisfied.

Comparative Example 4 is a case where the (Ba+Ca)/Ti ratio is too large. It is thought that when the (Ba+Ca)/Ti ratio was increased to this extent, sintering of the barium titanate particles was inhibited, making it impossible to obtain a dense sintered body.

It is considered that in Comparative Example 5, the amount of rare earth elements was too low, resulting in insufficient grain growth suppressing effect.

Similarly, in Comparative Examples 6 and 7, too much rare earth element or too little manganese would significantly delay sintering, making it impossible to obtain a dense sintered body.

Comparative Example 8 is a case where there is too much manganese. In this case, while a dense sintered body was obtained, the excess manganese reacted with the internal electrode layer and formed an oxide, turning the electrode into an insulator, resulting in no electrical connection and no longer functioning as a capacitor.

Comparative Example 9 is a case where the amount of borosilicate glass is too small, but it is thought that densification was insufficient because the amount of glass as a sintering aid was too small in a composition system with a very high (Ba+Ca)/Ti ratio.

It is thought that in Comparative Example 10, the amount of borosilicate glass added was too large, resulting in an open circuit state in which electrical connection could not be established. In this case, unlike the case of manganese, the cause is that some of the components of the internal electrode layer were carried away and dissipated by the glass whose viscosity was reduced (liquefied) during the sintering process.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
a plurality of internal electrodes facing each other;
a plurality of dielectric layers, each of which includes a main component, a first subcomponent, a second subcomponent, and a third sub component, and is sandwiched between the plurality of internal electrode; and
an external electrode that is electrically connected to at least a part of the plurality of internal electrodes,
wherein the main component has a perovskite structure expressed by a general expression ABO₃, includes titanium and includes at least one of barium or calcium,
wherein a molar ratio of a sum of barium and calcium to titanium is 1.045 or more and 1.100 or less, in the main component,
wherein the first sub component includes 3 mol or more and 6 mol or less of a rare earth element, with respect to 100 mol of titanium in each of the plurality of dielectric layers,
wherein the second sub component includes 3 mol or more and 7 mol or less of manganese, with respect to 100 mol of titanium in each of the plurality of dielectric layers, and
wherein the third sub component includes 0.6 weight % or more and 2.4 weight % or less of borosilicate glass with respect to each of the plurality of dielectric layers.

2. The multilayer ceramic electronic device as claimed in claim 1, wherein the rare earth element is at least one of scandium, yttrium, cerium, neodymium, europium, gadolinium, terbium, dysprosium, holmium, erbium, or ytterbium.

3. The multilayer ceramic electronic device as claimed in claim 1, wherein an average grain diameter of dielectric grains included in each of the plurality of dielectric layers is 150 nm or less.

4. The multilayer ceramic electronic device as claimed in claim 1, wherein a thickness of each of the plurality of dielectric layers is 10 μm or less.

5. The multilayer ceramic electronic device as claimed in claim 1, wherein the multilayer ceramic electronic device satisfies temperature characteristic X7E, temperature characteristic X7D or temperature characteristic X7C of EIA standard.

6. The multilayer ceramic electronic device as claimed in claim 1, wherein a relative dielectric constant of each of the plurality of dielectric layers is 600 or more.

7. The multilayer ceramic electronic device as claimed in claim 1, wherein a dielectric loss tangent of the plurality of dielectric layers is 0.01 or less.

8. The multilayer ceramic electronic device as claimed in claim 1, wherein a molar ratio of boron to silicon in the third subcomponent is 0.4 or more and 0.8 or less.

9. A dielectric material comprising:
a main component, a first sub component, a second sub component, and a third sub component,
wherein the main component has a perovskite structure expressed by a general expression ABO₃, includes titanium and includes at least one of barium or calcium,
wherein a molar ratio of a sum of barium and calcium to titanium is 1.045 or more and 1.100 or less, in the main component,
wherein the first sub component includes 3 mol or more and 6 mol or less of a rare earth element, with respect to 100 mol of titanium in the dielectric material,
wherein the second sub component includes 3 mol or more and 7 mol or less of manganese, with respect to 100 mol of titanium in the dielectric material, and
wherein the third sub component includes 0.6 weight % or more and 2.4 weight % or less of borosilicate glass with respect to the dielectric material.
